(19) United States
(12) Patent Application Publication
(10) Pub. No.: US 2015/0381793 A1
(43) Pub. Date: Dec. 31, 2015

(54) Bracelet with buttons remotely connected to a smart phone information accessing system

(71) Applicants: Anthony Cerda, Bedminster, NJ (US); Paulenne R. Kirschenbaum, Lakewood Ranch, FL (US)

(72) Inventors: Anthony Cerda, Bedminster, NJ (US); Paulenne R. Kirschenbaum, Lakewood Ranch, FL (US)

(21) Appl. No.: 14/120,787

(22) Filed: Jun. 30, 2014

(51) Int. Cl. H04M 1/725; G06Q 20/32; G06F 19/00; H04B 5/00; H04W 4/00

(52) U.S. Cl. CPC H04M 1/72527; H04M 1/72541; H04B 5/0031; H04W 4/008; G06F 19/323; G06Q 20/3278

(57) ABSTRACT

A smart phone remotely communicated with a bracelet that has a plurality of buttons and is worn by a user. When the user presses one of the buttons, this action by the user is communicated to a smart phone 'App, which executes user defined functions for each of the buttons. A first button is designed to display on the screen of smart phone critical medical data of the user in an emergency situation to reduce medical errors. The first button also retrieves more detailed data from the website and emails that data to medical personnel administering emergency care. A second button enables credit card transactions through a near field communication chip incorporated in the bracelet and the smart phone.

### 1. FIELD OF THE INVENTION

The present invention relates to information accessing systems; and more particularly, to a system wherein a bracelet having a plurality of buttons is remotely connected to a smart phone to trigger convenient, effective access to data retrieved thereby and/or previously stored thereon.

### 2. DESCRIPTION OF THE PRIOR ART

Numerous prior art patents and disclosures relate to communication between a bracelet and a smart phone. None of these references disclose use of a plurality of buttons which, when pressed, carries out functions previously defined by the user.

U.S. Pat. No. 7,438,216 to Ambekar, et al. discloses Medical information access and processing system. This medical information access and processing system includes a plurality of different wireless tag reader devices and a plurality of interfaces. These interfaces receive tag information from tag reader devices, which read a plurality of corresponding identification tags. At least one repository of map information associates tag information received from the reader devices. Reader device specific actions are performed by a medical information access and processing system. A data processor uses the map information to associate tag information received from a specific reader device via an interface with a corresponding action to be performed by the medical information access and processing system. The data processor automatically initiates performance of the corresponding action by the medical information access and processing system. This tag-based system collects data, which is stored in a central web based network, and information is accessed using tags. When the patient's wrist band is scanned, the system provides medical data. The wrist band is not a bracelet and does not have a plurality of buttons operative, when pressed, to execute a particular function triggered by the remote connectivity of the bracelet to a smart phone having a specialized 'App.

U.S. Pat. Nos. 8,315,617 to 8,684,900, 8,684,922, 8,708,903, 8,727,978 to Tran, collectively addressed in connection with U.S. Pat. No. 8,684,922 disclose a Health monitoring system. This monitoring system for a person includes a processor coupled to one or more wireless nodes; a wearable mobile appliance in communication with the client and one or more wireless nodes; and one or more computer implemented agents with rules executed by the processor. The rules are selected to respond to a client communication relating to a predetermined health condition. Each agent communicates with another computer implemented agent, the client or the treatment professional. Upon receiving a communication from the client, the processor selects one or more computer implemented agents to reply with an instruction on healthy client behavior. This system monitors the health status of a person and remotely communicates with a mesh network collecting medical information about the person wearing the wristwatch. Specifically, the wristwatch of the system does not connect remotely to a smart phone and the watch or bracelet worn by the user does not have buttons that have functionality selected by the user. The bracelet of the subject invention disclosure does not connect to a mesh network. The Smart phone of the Tran patent disclosure does not have an 'App that drives the execution of preprogrammed functions.

U.S. Pat. No. 8,600,776 to Raduchel discloses Records access and management. This electronic device aggregates electronic medical records, so that electronic medical records are aggregated from multiple electronic repositories and displayed as a single set of records. The multiple electronic repositories may store records for a particular patient using varying identifying/access information to facilitate anonymous access to the electronic medical records. Emergency medical services providers may be able to access medical records for a patient using the electronic device after being authenticated as a valid/licensed medical services provider. The data present in patient's electronic device is aggregated from several medical databases. It is not entered by the user and is stored as a short form, notepad document within the smart phone. The short form and detailed information is not sent by the user to a remote secure private database in the web and is not transmitted by the remote database server to the smart phone of the user.

U.S. Patent Application No. 20130044215 to Rothkopf et al. discloses a Bi-stable spring with a flexible display. This wearable accessory device includes a flexible display coupled to a bi-stable spring. Coupling the display to the bi-stable spring allows the accessory device to be easily worn in a number of convenient locations. A flexible substrate comprises an electronic module in communication with the flexible display. The electronic module provides information to the display, at least a part of which is presented in real time for presentation by the flexible display. The flexible display is touch-sensitive, and is in communication with a portable electronic device. The flexible display band worn on the wrist of a user communicates wirelessly with a portable electronic device and has touch screen capability. The flexible display is not indicated to interact with an 'App in the smart phone. The flexible display does not have physical buttons that are programmed to provide specific functionality.

Based on the foregoing, there exists a need in the art for an easy to use bracelet worn by a user that has a plurality of buttons, each of which is assigned with a specific function defined by the user and is remotely connected with a smart phone that carries out predefined functions. Such a system would advantageously provide for effective efficient access to preselected information, since the user would not have to operate the smart phone to access web pages in order to obtain access to critical information in an emergency situation.

### SUMMARY OF THE INVENTION

The present invention provides a method and device that comprises a bracelet having a plurality of buttons. When pressed, the bracelet with the buttons communicates with an 'App present in a smart phone. One button may be assigned to bring out critical medical information including blood type of the user, details of any operative procedures previously conducted, medications in use and the like. This critical information may be drawn by the 'App from a note pad type document present in the smart phone. The information may additionally be retrieved from a remote web based database which has been previously uploaded with the critical medical information as well as any recent medical records generated at the doctor's office during a previous doctors office visit. This doctor's office data has been previously uploaded to the remote database by the user and, upon the Smart phone accessing the remote database, this information is delivered by the remote database to the smart phone as an email. The user may forward this medical data to any provider that is treating the user in an emergency situation. The critical medical data, which is generally a short summary, is displayed on the screen of the smart phone and can be shown to a medical practitioner treating the user in an emergency situation. This procedure avoids medical errors such as, for example, transfusing wrong blood type, administrating an incompatible drug that has severe drug interactions and the like, without the need to test the patient for blood type, drug interaction and the like, which may take significant time and thereby prevent prompt, effective treatment of the user in an emergency situation.

The bracelet worn by the user has a plurality of buttons, each of which is programmed to remotely communicate a specific function to an 'App present in a smart phone. This remote communication may be accomplished by Bluetooth communication, infrared wireless communication or WIFI communication, each of which communication modes is compatible with a smart phone. Accordingly, the bracelet worn by the user has a battery to power the device and communication circuits for communicating with the smart phone.

The smart phone has a downloaded 'App from the website that administrates the bracelet device. The 'App requires the user to sign in the user name, password, Smart phone number and the user's email address. The user assigns functions for each of the buttons in the bracelet and the assigned functions are stored both in the remote website as well as in the smart phone 'App. The remote communication between the bracelet and the smart phone may be in the form of Bluetooth communication, Infrared communication or WIFI communication. For example, the first button may require the Smart phone to display, as a short form note-pad document in the screen of the smart phone, the medical history stored in the memory of the Smart phone. This record is previously recorded by the user or is acquired from the remote website as data that has previously been uploaded by the user. The user may also upload medical records generated during a previous visit to the doctor; this data, in the form of a scanned page or as a text or word document, is updated by the user on the remote Internet connected web site. When the remote website is contacted by the smart phone upon pressing of the first button, the website downloads the recent data into the Smart phone as an email. The user can direct the email to the emergency doctor's computer to provide recent medical history. In this manner, the complete data of the user is available to a medical professional attending to the user in an emergency situation and treatment can be administered without undue delay while, at the same time, avoiding medical mishaps or problems such as transfusing wrong blood type or administering incompatible medications.

In a similar manner, the other buttons in the bracelet may be assigned different functions, for example the second button may be programmed to activate a near field communication NFC chip with Blink technology that allows credit card processing by waving the bracelet in close proximity to a merchant point of sale terminal. Pressing the second button may transmit a preselected signal to the smart phone using an NFC chip to activate a transaction. The credit card information, bank account numbers, security passwords and the like are each functionally defined in accordance with user requirements.

Briefly stated, the bracelet has a plurality of buttons, each of which has been assigned with a specific function. The bracelet communicates remotely with a Smart phone having a specialized 'App that executes the assigned functions for each of the buttons. The remote communication between the bracelet and the smart phone is effected through a Bluetooth, infrared or WIFI communication protocol, which indicates that a specific button has been pressed by the user. The first button, for example, may be assigned to retrieve critical information needed when treating the user in an emergency situation. This short form may contain user's blood type, any previous operations or procedures carried out, a medication list administrated to the patient, and the like. Such data is recorded as a smart phone note pad document and stored in the memory of the smart phone. When the smart phone receives remotely the aforesaid information, the button for medical information retrieval is pressed by the user. The 'App of the smart phone retries the notepad recorded data, and displays it on the screen of the Smart phone. This data can be shown to the medical personnel treating the user in an emergency situation. This prevents medical errors, such as transfusion of wrong blood type or administration of incompatible medications to the user. It allows treatment to proceed in an efficient, effective manner without need to conduct laboratory tests or other time consuming procedures. The Smart phone may concomitantly communicate with a web based remote server to which the user previously down loaded the same short form, as well medical history generated during a recent visit to a doctor. Since the recent history uploaded by the user to the remote server is a large document, it is sent to the smart phone as an email. The user can direct the received email to the computer or smart phone of a medical person that is currently treating the user in an emergency situation.

The other buttons provided on the bracelet have other critical functions, which are defined by the user. They may include, for example, activating an NFC chip present in the bracelet; or triggering remote communication with a Smart phone activating NFC chip, which resides in the Smart phone; or merely displaying credit card information, bank account numbers, security passwords and the like on the smart phone screen display. In this manner, the screen of the smart phone may display critical information, and detailed data may be stored in the remote web based database. Since the user loads all the data to the remote database securely, this data is not accessible to unauthorized users. In its preferred embodiment, the smart phone information accessing system of the present invention, comprises:
1) a bracelet worn by the user having a plurality of buttons;
2) the bracelet communicating with an 'App loaded on a Smart phone using a remote communication protocol selected from the group consisting of Bluetooth, Infrared or WIFI;
3) the 'App executing functions in accordance with user assigned functions and communicating with an Internet based web database to acquire desired information;
4) a first button providing critical medical information which may be needed during treatment of the user in an emergency situation, the critical medical information being displayed on the screen of the Smart phone and containing data that comprises user's blood type, previous operations and medical procedures as well as medications currently in use, so that blood of wrong type is not infused or incompatible medication is not administered;
5) said 'App communicating with a remote database to acquire detailed doctor generated data, which is transmitted as an email to the Smart phone and, optionally, directed to the medical personnel's computer by the user;
6) a second button assigned to a credit card processing microchip using near field communication and present either in the bracelet or the smart phone remotely connected to the bracelet, for facilitation a secure credit card transaction; and whereby the bracelet provides an enhanced level of security while operating in concert with said Smart phone to provide critical data to the user.

### BRIEF DESCRIPTION OF THE DRAWINGS

The invention will be more fully understood and further advantages will become apparent when reference is had to the following detailed description of the preferred embodiments of the invention and the accompanying drawing, in which:

FIG. 1 illustrates the key elements of the bracelet with buttons that remotely connect to a smart phone 'App information accessing system;

FIG. 2 is a schematic illustration of the steps involved in the operation of the Button Containing Bracelet Triggered Smart phone Information Accessing System to provide medical information in an emergency situation; and

FIG. 3 is a schematic illustration of the steps involved in the operation of the Button Containing Bracelet Triggered Smart phone Information Accessing System to facilitate an accurate, convenient, cost-effective credit card-type transaction.

### DETAILED DESCRIPTION OF THE INVENTION

This invention relates to a bracelet with buttons remotely connected to a Smart phone information accessing system (hereinafter the “Button Containing Bracelet Triggered Smart phone Information Accessing System”). Particularly, the Button Containing Bracelet Triggered Smart phone Information Accessing System comprises a bracelet with a plurality of buttons which when pressed establishes remote communication with a smart phone. The smart phone is equipped with a specialized 'App that executes appropriate functions desired by the user. This remote communication may be in the form of Bluetooth communication, Infrared communication or WIFI communication.

The objective of the invention is to enable easy access to functions normally used by the wearer. A plurality of buttons are incorporated into a bracelet worn by the user. Each button is assigned to trigger a specific functionality, which is carried out by a Smart phone. This assignment may involve displaying information stored in the memory of the smart phone in the form of a short document. The data is displayed on the screen display of the smart phone. The smart phone may access a secure privately controlled web server that carries important information such as medical data uploaded by the user. When a selected assigned button is pressed, the Smart phone displays a summary sheet containing data recorded from data stored in the smart phone or acquired by contacting the secure private web database. If a large amount of data resides in the secure web database, it is sent as an email to the user's smart phone and the user may direct this email to any computer according to need.

Specifically a first of the buttons on the bracelet is assigned to retrieve critical medical information during an emergency situation. The user has saved a notepad-type document containing critical information, which includes a user's blood. type, any previous operations or medical procedures as well as medication currently in use. This document is essentially short and can be easily displayed in the screen display of the smart phone. This entered data is also transmitted to a secure remote web site of the system. The user may upload to the secure private website any recent medical data generated during a medical visit in the form of a scanned document or a Microsoft Word file, and this data will be emailed to the email address of the smart phone when the remote website is contacted by the smart phone. The user has the ability to send the emailed data to the computer of the emergency medical personnel. In this manner, relevant data is immediately available to be accessed by the emergency medical personnel without the need to wait for lab work. This, in turn, results in rapid, reliable, cost-efficient medical service.

Another button may be defined to enable credit card transactions using near field communication protocol present in many of today's credit cards This so-called Blink technology is similar to RFID. It can communicate both ways with the interrogating host and enables secure credit card transactions. The Blink chip may be present in the smart phone as well as the bracelet and is activated by the remote communication between the bracelet and the Smart phone. The user brings the smart phone or the bracelet in close proximity with the point of sale reader.

Other buttons may be assigned to conduct different functions according to the user's preferences.

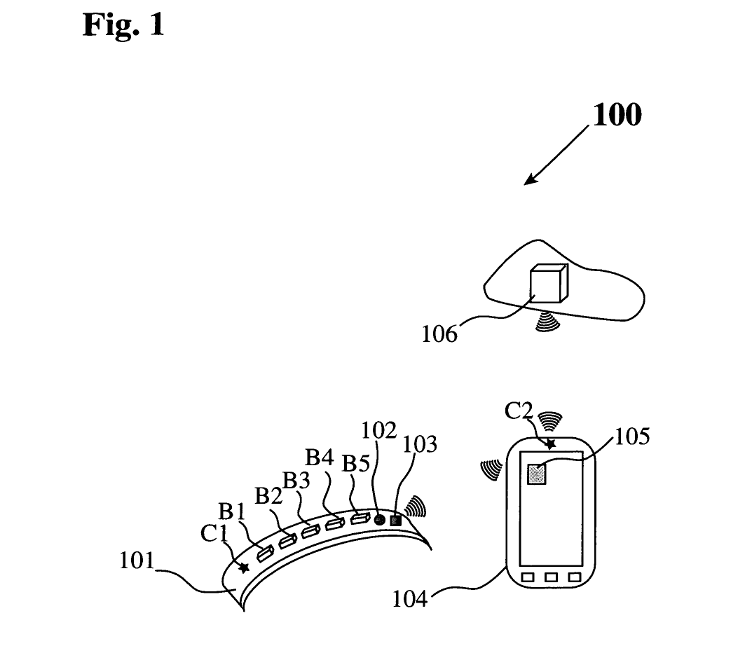

FIG. 1 illustrates generally at 100 the key elements of the bracelet with buttons that remotely connect to a smart phone 'App information accessing system. Pressing one of the plurality of buttons activates a specific function. In this figure, 101 illustrates a bracelet appointed to be worn by a user. Bracelet 101 has a plurality of buttons, as shown at B1, B2, B3, B4 and B5. The bracelet contains a battery 102 and has a processing unit 103 which identifies which of the buttons has been pressed and remotely communicates with an 'App 105 in a smart phone 104 using Bluetooth, Infrared or WIFI at protocols, as shown by the transmitting symbols. The smart phone has internal memory within which short forms for each of the buttons may be stored. Each of these short forms, containing readily accessible critical information, may be stored in the form of a notepad file. Depending on which button is pressed, the short form is displayed on the display screen of the smart phone. For example, if button B1 is pressed, the medical short form stored in the smart phone memory is displayed on the screen of the smart phone and shows the blood type of the user, any medical procedures previously carried out, as well as mediations in use. The smart phone also communicates with the cloud secure private database shown at 106 and receives more detailed information. This detailed information is originally uploaded when the user records a doctor-generated document created during a recent doctor's office visit. This detailed information is sent from a cloud database computer to the smart phone 104 by an email; and the user may direct the email to appropriate medical or other personnel.

Both the smart phone and bracelet may contain near field communication (NFC) chips C1 and C2 that enable payments using a credit card type transaction. When the user presses B2, the Smart phone 'App activates both C1 and C2. These chips are provided or programmed by a credit card issuing authority and are Blink technology devices. All the user needs to do is to bring the bracelet or smart phone into close proximity with the point of sale station.

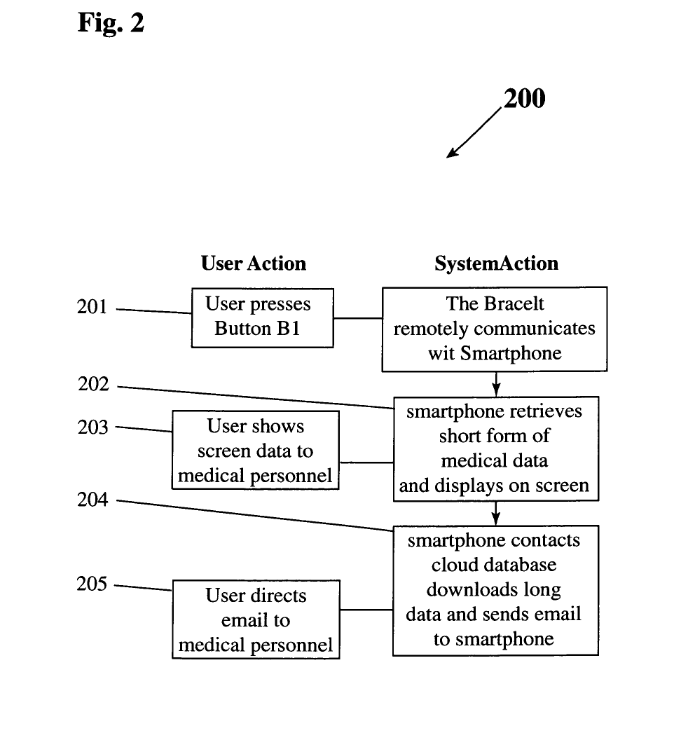

FIG. 2 illustrates generally at 200 the steps involved with operation of the Button Containing Bracelet Triggered Smart phone Information Accessing System to provide medical information in an emergency situation. At step 201 the user presses button B1, which is assigned to retrieve emergency information during an emergency such as an accident involving the user. The bracelet communicates remotely to the

Smart phone, indicating that button B1 has been pressed. The 'App in the smart phone executes the script of previously defined instructions. At step 202, the smart phone retrieves the short form of medical information previously entered into the smart phone by the user. This information may include user's blood type, any previous operations or medical procedures and a list of medications currently in use. During the process of providing medical help in an emergency, medical mishaps can easily occur and use of lab facilities to determine blood type, implants or other medical procedures takes a long amount of time. Medicines that are currently in use cannot be determined easily since the concentration of medicines within the body changes as a function of time. This short form medical information is displayed on the screen of the Smart phone so that the user may show this critical data to any medical professional attending the emergency situation. At 203, the user shows the short form medical data to medical personnel. In addition to the short form, the user may upload recent medical data generated during a visit to the doctor's office. This data generated is generally extensive and comprises blood test results, comments by the doctor and the like. The user may scan this data as a pdf file or create a Word document and upload it to a secure private cloud database. When the smart phone contacts the secure private cloud database, an email of the extensive data is sent to the Smart phone of the user, as shown in step 204. The user may redirect the email from the cloud secure database to the medical personnel's computer as shown at step 205. In this manner, the emergency medical personnel are provided with updated medical data to optimize procedures used during treatment.

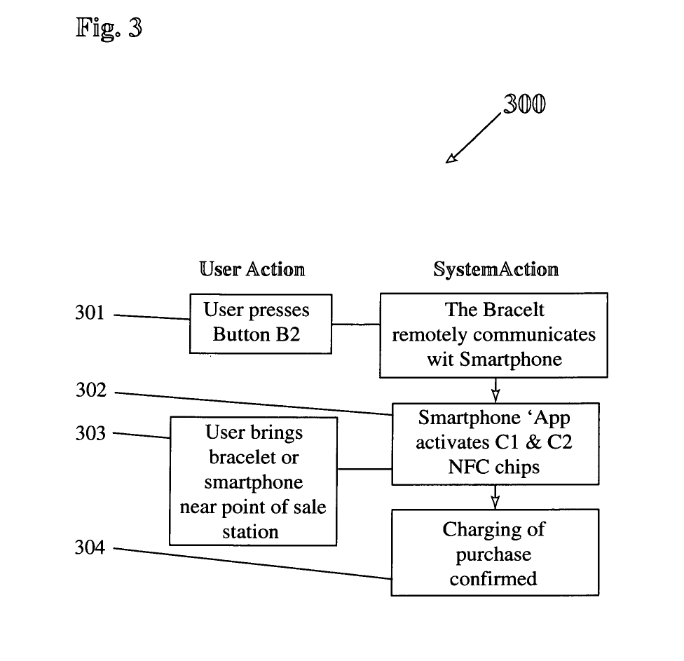

FIG. 3 illustrates generally at 300 the steps involved with operation of the Button Containing Bracelet Triggered Smart phone Information Accessing System to provide a fast credit card type transaction. At step 301 the user presses button B2 that is assigned to conduct a credit card type transaction. The bracelet communicates remotely with the Smart phone, indicating that button B2 has been pressed. At step 302, the smart phone 'App activates the near field BFC chips C1 of the bracelet and C2 of the smart phone. At step 303, the user brings the bracelet or the smart phone into close proximity with a point of sale processing station. At step 304, the charging of the purchase is confirmed.

Having thus described the invention in rather full detail, it will be understood that such detail need not be strictly adhered to, but that additional changes and modifications may suggest themselves to one skilled in the art. For example, Bracelet 101 can be modified to additionally house a chip which contains readily accessible critical care information. The critical information can be stored in the form of a notebook file or the like, which is subject to being accessed by an 'App resident on a second Smart phone, such as the Smart phone of a close relative, traveling companion, or resident nurse, or the like, that has been provided with a special 'App access code. It can also be subject to access by an emergency care provider. When button B1 on the Bracelet 101 is pressed, the Bracelet 101 endeavors to communicate with Smart phone 104. In the event that Smart phone 104 is not accessible or is inoperable due to lack of battery power or the like, the chip resident on the Bracelet 101 can still provide critical information to the 'App containing Smart phone of the emergency care provider. Each of these modifications, as well as other changes and modifications of the System 100 are considered to all falling within the scope of the invention as defined by the subjoined claims.

1. A smart phone information accessing system, comprising:
a) a bracelet worn by the user having a plurality of buttons;
b) each of said buttons being operated by the user, one at a time;
c) each button having specific user assigned functionality;
d) said bracelet communicating with an 'App loaded on a smart phone using a remote communication protocol operable to indicate that a particular button has been pressed;
e) said 'App executing user assigned functions for the particular button;
f) a first button being allocated (i) to retrieve critical medical data previously entered and saved by the user in the memory of said smart phone and (ii) to subsequently display said critical data on the screen of said smart phone for use by medical personnel during an emergency.,
g) said bracelet comprising a chip that contains readily accessible critical care information; and
h) said bracelet having a near field communication chip enabling a credit card transaction,
wherein a second button in the bracelet is allocated to conducting credit card transactions using the near field communication chip;
whereby the bracelet provides an enhanced level of security while operating in concert with said smart phone to provide critical data to the user.

2. (canceled)

3. The smart phone information accessing system as recited by claim 1, wherein said bracelet remotely communicates with the smart phone using Bluetooth.

4. The smart phone information accessing system as recited by claim 1, wherein said bracelet remotely communicates with the smart phone using infrared wireless protocol.

5. The smart phone information accessing system as recited by claim 1, wherein said bracelet remotely communicates with the smart phone using WIFI.

6. (canceled)

7. The smart phone information accessing system as recited by claim 1 wherein said critical data comprises user's blood type, previous medical procedures and medications in use.

8. The smart phone information accessing system as recited by claim 1 wherein said first button is additionally allocated to retrieve large medical data generated during a previous visit to a doctor's office and thereafter uploaded and saved by the user in an Internet based remote secure web site, and the smart phone retrieves said larger data and sends an email to said medical personnel.

9. (canceled)

10. (canceled)

11. The smart phone information accessing system, as recited by claim 1, wherein said critical care information stored on said chip is accessed by an 'App resident on a smart phone.

12. The smart phone information accessing system, as recited by claim 11, wherein said critical care information stored on said chip is subject to access by an 'App resident on a second smart phone.

13. The smart phone information accessing system, as recited by claim 12, wherein said 'App on said second Smart phone is operable to access said critical care information on said chip when provided with a special access code.

14. The smart phone information accessing system, as recited by claim 13, wherein said second Smart phone is the Smart phone of a close relative, traveling companion, resident nurse or emergency care provider.
